(19) United States
(12) Patent Application Publication
(10) Pub. No.: US 2011/0270601 A1
(43) Pub. Date: Nov. 3, 2011

(54) UNIVERSAL TRANSLATOR

(75) Inventors: VAHE NICK KARAPETIAN, SHERMAN OAKS, CA (US); GRIGOR PALANDZHYAN, SHERMAN OAKS, CA (US)

(73) Assignee: VAHE NICK KARAPETIAN, JR., SHERMAN OAKS, CA (US)

(21) Appl. No.: 12/769,476

(22) Filed: Apr. 28, 2010

(51) Int. Cl. G06F 17/28; G10L 21/00; G10L 11/00

(52) U.S. Cl. 704/4; 704/8; 704/277; 704/E21.001; 704/E11.001

(57) ABSTRACT

A speech translator includes a device adapted to be worn in the ear and includes means responsive to audible speech in a first language to convert that speech to electrical signals representing words and phrases and applying the signals to a database to retrieve other signals representing equivalent words and phrases in a second language. These other signals are applied to a loudspeaker and are audibly perceived as speech in the second language.

This invention relates to a communication device and, more particularly, one-piece earpiece that is a translation device. Within the earpiece, according to one embodiment, the entire translation process occurs. It is very important to note that there is no secondary device coupled with the invention that is necessary to the translation process. This translation device converts Language A to Language B in real time and orally dictates the translation into a user's ear in conversational (word for word) speed by recognizing frequencies/pitches of the spoken language (Language A) then converting into the desired language (Language B).

### BACKGROUND OF THE INVENTION

The world has become a smaller place due to inventions like the television, telephone and internet. The world's people have been brought together through technology, but there is still one problem that exists on an international level. That problem is the language barrier.

The language barrier problem affects the lives of almost everyone in the world. International travelers, family members who live abroad and who don't speak the same language, businessmen, foreign diplomats, police officers who don't understand the languages of the minorities in their communities, soldiers in foreign countries (i.e. US troops in Iraq, Afghanistan), etc.

There have been attempts made to fix this problem, but none are practical especially in a real-time conversation. In the early days of trading on the Silk Road, traders needed to be fluent in more than one language. As civilization progressed, translation books were created that had word for word translations as well as complete phrase translations. In the computer age, a technological advancement allows users to translate whole texts from one language into another. None of these “solutions” can be used practically in a real-time conversation.

### BRIEF DESCRIPTION OF THE INVENTION

The present invention, in a preferred embodiment, is a one-piece device that is wireless and is able to translate speech in Language A to speech in Language B, where Language A and Language B can be any combination of languages. In one embodiment it may also be programmable to translate multiple languages. Language A to Language B translation occurs in real-time conversational speech. Once a computer chip receives the audio frequencies comprising a message in Language A. it will translate them into frequencies comprising Language B. Once the chip translates the message into Language B, text-to-speech software will be able to orally dictate the translation into the user's ear.

In alternative embodiments, the device will translate individual words. This whole process occurs within the device, which may be an earpiece. In the preferred embodiment, no secondary translation devices are used during the process. All translations are in real time conversational speed and are not delayed for a prolonged period nor are they converted using a phrase-by-phrase method.

In a preferred embodiment using present technologies, memory elements within the device can be large enough to store a vocabulary of up to three languages. However, it is envisioned that in the near term, miniaturized memory devices of greater capacity will permit the storage of more than three languages in a form that will allow ready conversion from one language into another.

In alternative embodiments, the device may include electronic transmission capabilities so that the language databases can be remotely stored and accessed. This can effectively remove any size limitations that might restrict the use or versatility of the device. All embodiments may employ noise cancelling devices to reduce the effect of ambient or background noise.

Current translation methods are not realistically practical in a conversation. Learning every language in the world is not realistic. Translation books are time consuming and impractical in conversational situations. Computer translation devices are good, but have two big problems. The first problem is that one needs to have the conversation in text format and have a computer in order to get the program working, thus making normal oral conversations impossible. The second problem is that the visually impaired cannot read the text from the screen.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF DRAWINGS

FIG. 1 is a block diagram of the components of the present invention;

FIG. 2 is a front perspective view of a preferred embodiment of the device of the present invention;

FIG. 3 is a side perspective view of the device of FIG. 2;

FIG. 4 is a rear perspective view of the device of FIG. 2;

FIG. 5 is an electrical diagram of an alternative embodiment of the present invention; and

FIG. 6 is a diagram of an alternative embodiment with a remote database.

### DETAILED DESCRIPTION OF DRAWINGS

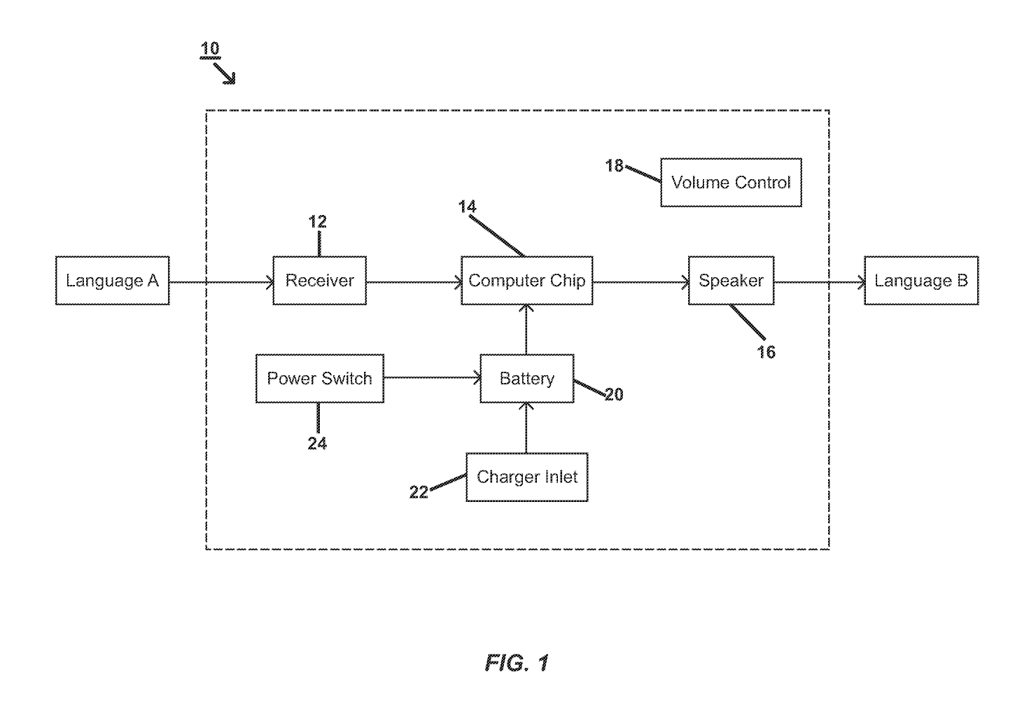

Turning to FIG. 1, there is shown, in block diagrammatic form, the components of the present invention. 10. A audio receiver 12 accepts sound inputs comprising a message in Language A and converts it into a stream of corresponding electrical signals which are applied to a computer chip 14.

The chip 14 is programmed to accept signals corresponding to and representative of a spoken message which may be converted into signals representing a digital text message. The computer chip 14 then, retrieves from a database, a set of electrical signals corresponding to and representative of the same message in Language B. in digital text. These digital text signals are converted to signals which, when applied to a speaker 16 are transduced into a synthesized voice which audibly communicates the message in Language B.

A volume control 18 is connected to the speaker 16 which allows the user to moderate the volume of the speaker 16 output. A power source, in this case a battery 20 powers the system 10. A charging unit 22 is provided which includes a transformer so that a power source, such as the 110 volt a.c. current normally found in households, can be used as an alternative source and can recharge the battery 20. A power switch 24 is provided so that the system 10 is only active when needed for speech translation.

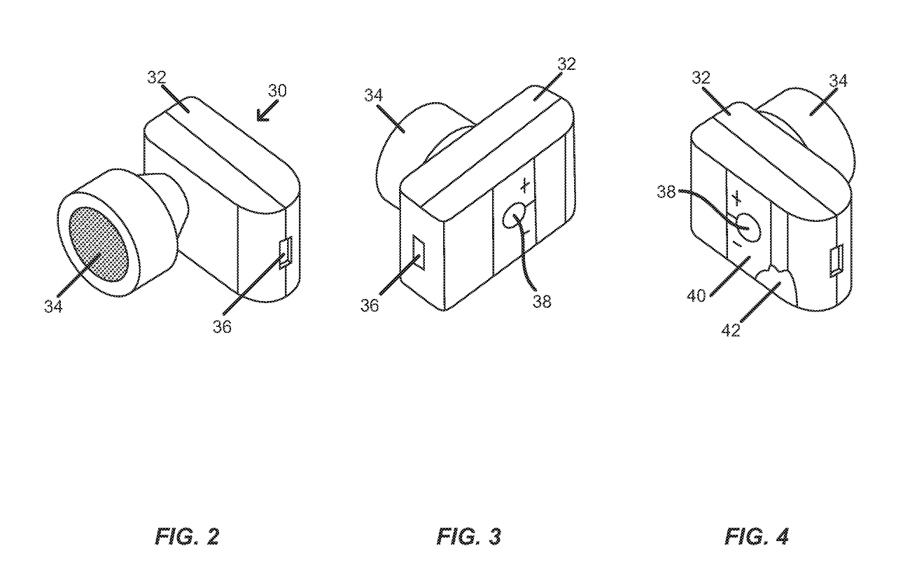

Turning next to FIG. 2, there is shown a preferred embodiment of the system of the present invention. The unit 30 is packaged in a case 32 which includes a speaker/earpiece 34. A microphone 36 is installed in a side end of the case 32 and detects the speech that is to be translated.

In FIGS. 3 and 4 a power switch 38 is shown in the back of the case 32. A volume control 40 allows the listener to control the sound level. A computer chip 42 is also shown

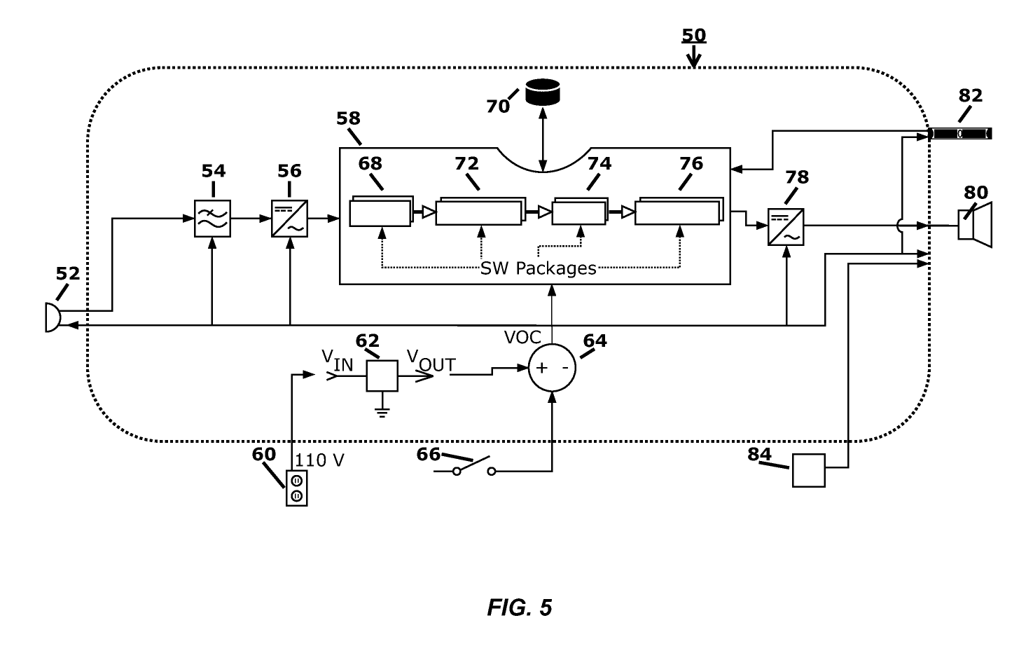

FIG. 5 is a diagram of an alternative embodiment of the present invention. A unit 50 has a microphone 52 which transduces sounds into an analog audio signal that is applied to a noise cancelling filter 54 whose output is applied to an analog to digital converter 56 which supplies a digital signal train to a translation block 58.

Power is derived from a 110 a.c. voltage source 60 which is applied to a voltage regulator 62 that reduces the voltage to a level that can charge a battery 64 which powers the unit 50. A switch 66 enables control of the provision of power.

Within the translation block 58, there is a language recognition element 68 which communicates with a memory storage device 70 that contains the several languages that can be recognized and substituted for the speech that is spoken into the microphone 52. In this embodiment, a digital audio to text converter 72 applies text signals to a text translator 74 which converts the text of Language A to the text of Language B. The Language B text is applied to a text to digital audio converter 76 whose digital output is applied to a digital to audio converter 78 producing an audio output signal.

The audio output signal is applied to a speaker 80. A language selector switch 82 which controls the text translator 74, enables the selection of Language A and Language B for the process. A volume control 84 permits an adjustment of the speaker 80 volume,

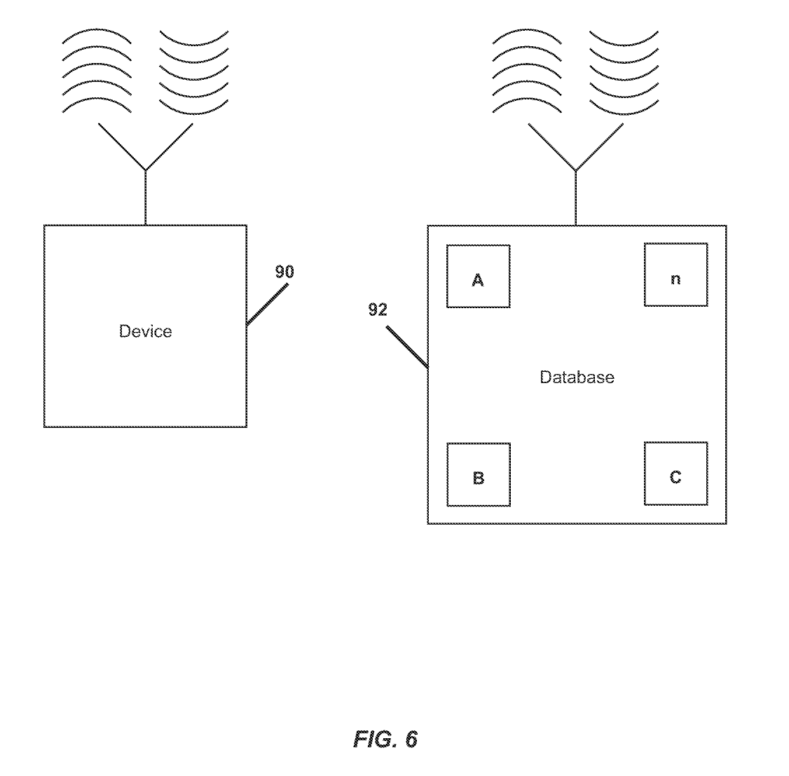

In FIG. 6, there is shown a diagram for an alternative embodiment in which the databases containing the various languages are stored remotely and are accessed through wireless communication techniques. As shown, a device 90 wirelessly communicates with remote database 92 in which languages A, B, C through language N can be stored.

In operation, the earpiece device in which the system 10 is installed receives an audible message from an individual speaking in Language A. The Computer chip 14 converts this frequency into text using automatic speech recognition software at real time conversational speed. Once in text format, the source text goes through translation software and is converted into Language B. Finally, through speech synthesis the text is audibly delivered in Language B to the user's ear.

The device can be made either with a replaceable or rechargeable battery. The replaceable version has a door type opening that makes the battery easily accessible. The rechargeable version will accept the male end of the charger through an opening.

To use the invention, an individual would first need to either charge the device or insert a working battery to give the device power. Then the user needs to switch the device on and the device will be ready to receive audible speech from others who are talking. Once it is on, the user needs to insert the device into an ear and he will be ready to receive fast and easy real-time translations. To turn the device off, either flip the switch to the “Off” position or hold the power button for a predetermined interval.

The invention is not limited to simple language translation. It is true consumers will use it to convert foreign languages into known languages (i.e. Spanish into English) but the armed services/DoD can use the invention in many different ways. The passing on of secret codes and messages can be accomplished by this device. The device will be able to decipher any type audible message. Thus it will not be limited to known or common languages. By the simple modification of the software built onto the chip, the type of language or sound pattern or frequency that it will be able to translate can be changed.

In the alternate embodiments, as digitized words and phrases in Language A are received in the database 92, the corresponding words and phrases in the several other languages are selected and the desired Language N equivalent words or phrases are transmitted back to the device 90 and are converted into audible speech in Language N.

The device can also be used to teach people different languages at a more rapid pace than any of today's methods. The translation is not limited to words as they appear in the dictionary. Because different professions/industries have their own respective vocabularies (i.e. Doctors, Lawyers, Engineers, etc) the invention will be able to translate these terms as well.

Cellular telephones, Bluetooth® devices, and video conferencing software can use this type of software to make communication easier. Computers will be able to use this software and can apply it to their own systems, such as video conferencing. Machines such as cellular phones, Bluetooth® devices can be equipped with this type of software/application and can perform the same type of function.

Those skilled in the art will devise variations and the scope of the invention should only be limited by the scope of the claims appended hereto.

What is claimed as new is:

1. Apparatus for language translation comprising:
a. first transducer means for converting audible speech in a first language into first electrical signals;
b. conversion means connected to said first transducer means and responsive to said first electrical signals representative of words and phrases in the first language to provide second electrical signals representative of corresponding words and phrases in a second language; and
c. second transducer means for converting said second signals into audible speech in the second language.

2. The apparatus of claim 1, above, further including database means connected to said conversion means and having stored therein, signals representing words and phrases in at least first and second languages and including means for corresponding words and phrases in the first language to the equivalent corresponding words and phrases in the second language.

3. The apparatus of claim 1, above, further including database means storing signals representing a plurality of languages wherein signals representing words and phrases in a first language are corresponded to the equivalent words and phrases in each of the plurality of languages, whereby the selection of a translation from language A to language B causes the words and phrases in language A and B to be paired so that upon recognition of signals corresponding to particular words and phrases in Language A the equivalent words and phrases in Language B are presented to said second transducer means.

4. The apparatus of claim 1, above wherein said first transducing means include analog to digital converting means for supplying digital signals corresponding to words and phrases in a first language and wherein said second transducing means include digital to analog converting means for supplying audible signals representing words and phrases in a second language.

5. A method for language translation comprising the steps of:
a. converting audible speech in a first language into first electrical signals;
b. matching said first signals representing speech in said first language with second electrical signals representative of words and phrases in a second language corresponding to speech in said second language; and
c. converting said second electrical signals into audible speech in said second language.

6. The method of claim 5, above, further including the steps of storing signals representing words and phrases in at least first and second languages in a database and performing said matching step on said stored signals representing corresponding words and phrases in said first and second languages.

7. The method of claim 5, above, further including the steps of storing in a database electrical signals representing a plurality of languages wherein signals representing words and phrases in a first language are corresponded to the equivalent words and phrases in each of the plurality of languages allowing a translation from language A to language B by causing corresponding words and phrases in language A and B to be paired so that upon recognition of signals corresponding to particular words and phrases in Language A the equivalent words and phrases in Language B are converted to audible speech.

8. Apparatus for language translation comprising:
a. first transducer means for converting audible speech in a first language into first electrical signals;
b. first conversion means connected to said first transducer means and responsive to said first electrical signals representative of words and phrases in the first language to provide second electrical signals representative of corresponding words and phrases in a second language;
c. database means connected to said conversion means and having stored therein, signals representing words and phrases in at least first and second languages;
d. comparison means connected to said database means for corresponding words and phrases in the first language to the equivalent corresponding words and phrases in the second language in the form of second electrical signals; and
e. second transducer means for converting said second signals into audible speech in the second language.
